(19) United States
(12) Patent Application Publication
(10) Pub. No.: US 2018/0363667 A1
(43) Pub. Date: Dec. 20, 2018

(54) COMPRESSOR ROTOR AND AXIAL COMPRESSOR

(71) Applicant: KAWASAKI JUKOGYO KABUSHIKI KAISHA, Kobe-shi, Hyogo (JP)

(72) Inventors: Kentaro NAKAYAMA, Nishinomiya-shi (JP); Koji TERAUCHI, Kobe-shi (JP); Yusuke SAKAI, Kobe-shi (JP); Daisuke UEMURA, Kobe-shi (JP); Tomoko HAGARI, Akashi-shi (JP)

(73) Assignee: KAWASAKI JUKOGYO KABUSHIKI KAISHA, Kobe-shi, Hyogo (JP)

(21) Appl. No.: 16/062,999

(22) PCT Filed: Oct. 5, 2016
(86) PCT No.: PCT/JP2016/004480

§ 371 Date: Jun. 15, 2018

(30) Foreign Application Priority Data
Dec. 17, 2015 (JP) 2015-246550

(51) Int. Cl. F04D 27/00; F04D 29/32; F01D 5/30

(52) U.S. Cl. CPC F04D 27/009; F04D 29/322; F04D 29/542; F05D 2240/80; F05D 2240/20; F01D 5/303

(57) ABSTRACT

A compressor rotor including a structure for bleeding air flowing through a compressed air flowpath of an axial compressor to an inner passage provided on an inner peripheral side of the axial compressor, includes rotor blades and a rotor disc. The rotor disc includes a blade groove provided in an outer peripheral surface thereof and being continuous in a circumferential direction and a passage which communicates an inner region of the blade groove with the inner passage. The rotor blade has a root part and a platform which are fitted to the blade groove, and a blade part provided on a side opposite to the root part with the platform interposed between the root part and the blade part. An opening is provided in the platform or a region that is in the vicinity of the platform and configured to communicate the inner region of the blade groove with the compressed air flowpath.

### TECHNICAL FIELD

The present invention relates to a compressor rotor and an axial compressor (axial flow compressor) including the compressor rotor.

### BACKGROUND ART

A gas turbine engine includes as basic components a compressor which takes in and compresses air to generate high-pressure air, a combustor which combusts fuel with the compressed air to generate a high-temperature and high-pressure gas, and a turbine which causes the high-temperature and high-pressure gas to impinge on an impeller to rotate the impeller. The gas turbine engine is a prime mover which takes driving power out of the turbine.

Typically, the axial compressor of the gas turbine engine includes a rotor provided with a plurality of rows of rotor blades (a plurality of rotor blade rows) which are arranged in an axial direction at an outer peripheral surface, and a stator which surrounds the rotor and is provided with a plurality of rows of stator vanes (a plurality of stator vane rows) which are arranged in the axial direction at an inner peripheral surface. The plurality of rows of stator vanes and the plurality of rows of rotor blades are arranged in such a way that one row of stator vanes and one row of rotor blades are alternately placed. The compressor with the above-described configuration is able to take in the air, compress the intake air, and increase the air pressure, by functions of the stator vanes and the rotor blades rotating relative to the stator vanes. The compressed air generated by the compressor is used as combustion air in the combustor, or used to cool high-temperature components of the turbine or to seal lubricating oil.

Patent Literature 1 discloses a compressor including a bleed path used to bleed compressed air from a compressed air flowpath provided on the outer peripheral side of the rotor to an inner passage provided on the inner peripheral side of the rotor. The rotor of this compressor includes a plurality of rotor discs arranged in an axial direction, and a plurality of rotor blades extending radially outwardly from each of the rotor discs. This rotor is provided with the bleed path including an annular entrance formed between two adjacent rotor discs, a first passage which is an annular space and is connected to this entrance, and a second passage extending radially inwardly and axially from the first passage, inside the rotor disc. The compressed air is led from the compressed air flowpath to the inner passage through the bleed path, flows in the axial direction through the inner passage, is sent to the turbine, and cools the components provided inside the turbine.

### CITATION LIST

### Patent Literature

Patent Literature 1: US Patent Publication No. 2013/0283813

### SUMMARY OF INVENTION

### Technical Problem

A bleed structure of the compressor is required to bleed a part of a fluid without impeding a flow of the fluid inside the compressor, and to reduce a pressure loss of the bled fluid. It is desirable to meet this demand while reducing cost.

In the bleed path disclosed in Patent Literature 1, since the second passage is provided inside the rotor disc, the fluid flowing through the second passage swirls with the rotation of the rotor. To allow the fluid to easily flow into the second passage, the annular first passage is provided between the entrance of the bleed path and the second passage. The fluid flowing through the annular first passage does not swirl with the rotation of the rotor. For this reason, in the first passage, a swirl component of the flow of the fluid having flowed into the bleed path is reduced. The annular first passage is formed between adjacent rotor discs by cooperation of these rotor discs. It is necessary to perform machining processing to two adjacent rotor discs defining the first passage so that these rotor discs have high precision in position and shape.

The present invention has been developed in view of the above-described circumstances, and provides a bleed path structure including at least one passage which rotates with rotation of a rotor and an annular passage connecting this passage to a bleed air inlet, at reduced cost.

### Solution to Problem

According to an aspect of the present invention, there is provided a compressor rotor including a structure for bleeding air flowing through a compressed air flowpath of an axial compressor to an inner passage provided on an inner peripheral side of the axial compressor, the compressor rotor comprising: a rotor disc including a blade groove (channel) provided in an outer peripheral surface thereof and being continuous in a circumferential direction, and a passage which communicates an inner region of the blade groove with the inner passage; and a plurality of rotor blades each having a root part and a platform which are fitted to the blade groove, and a blade part provided on a side opposite to the root part with the platform interposed between the root part and the blade part, wherein an opening is provided in the platform or a region that is in the vicinity of the platform and configured to communicate the inner region of the blade groove with the compressed air flowpath.

According to an aspect of the present invention, an axial compressor comprises: the above-described compressor rotor; and a compressor stator including stator vanes corresponding to blade parts, respectively, of the compressor rotor.

In the compressor rotor and the compressor described above, the inner region of the blade groove is utilized as a part of the bleed path for bleeding the compressed air from the compressed air flowpath provided on the outer peripheral side of the rotor to the inner passage provided on the inner peripheral side of the rotor, and the bleed path is formed by the blade groove and the passage which are formed in the rotor disc. The opening formed between the platform of the rotor blade and the opening edge of the blade groove of the rotor disc is a bleed air inlet of the bleed path which opens in the compressed air flow path.

As described above, the blade groove provided in the conventional rotor is utilized as a part (annular passage) of the bleed path. In this structure, it is not necessary to form the annular passage (first passage) formed by the cooperation of the adjacent rotor discs disclosed in Patent Literature 1. This makes it possible to reduce a machined part of the rotor disc. As a result, machining cost can be reduced.

In the compressor rotor and the compressor described above, the opening may be provided at a location that is downstream in an axial direction relative to the blade part.

In this structure, the air having a swirl velocity component that is close to the rotation velocity component of the rotor is bled. As a result, bleeding of the air can be stably performed.

In the compressor rotor and the compressor described above, the opening may be a gap in an axial direction which is formed between an end portion of the platform in the axial direction and an opening edge of the blade groove.

In this structure, the opening can be provided at a location that is close to the rotor disc and downstream or upstream relative to the rotor disc. This can eliminate a need to expand a gap in the axial direction between this rotor disc and a stator vane which is adjacent to this rotor disc and upstream or downstream relative to this rotor disc. Therefore, the dimension of the rotor in the axial direction is not increased.

In the compressor rotor and the compressor described above, the passage may have a structure in which an exit which opens in the inner passage is located downstream in an axial direction relative to an entrance which opens in the blade groove.

In this structure, since the passage is inclined to a downstream side in the axial direction, from the entrance toward the exit, a component of the flow of the fluid flowing through the bleed path, the component being directed to the downstream side in the axial direction, can be increased.

In the compressor rotor and the compressor described above, the opening may constitute a continuous or intermittent annular slit in the outer periphery of the rotor disc.

Since the opening which is the bleed air inlet of the bleed path has the annular slit shape, a part of the fluid in the compressed air flowpath of the compressor can be bled to the bleed path through the opening, without impeding the flow of the fluid in the compressed air flowpath.

In the compressor rotor and the compressor described above, the inner entrance may open in a bottom wall of the blade groove, and a space which is continuous in the circumferential direction may be provided between the bottom wall of the blade groove and the root part.

In the space which is continuous in the circumferential direction, the fluid can move in the circumferential direction. Even in a case where the number of passages connecting the inner region of the blade groove to the inner passage is set to a value less than the number of the rotor blades, bleeding of the air from the whole periphery can be performed in a well-balanced manner.

In the compressor rotor and the compressor described above, the rotor disc may include a guide part which guides a fluid having flowed out through the exit to a downstream region in an axial direction.

In this structure, a component of the flow of the fluid having flowed out to the inner passage of the compressor through the exit of at least one passage (bleed path), the component being directed to the downstream side in the axial direction X, is increased.

### Advantageous Effects of Invention

In accordance with the present invention, in a compressor rotor and a compressor, a bleed path including at least one passage which rotates with rotation of a rotor and an annular passage connecting this passage to a bleed air inlet, can have a structure formed at reduced cost.

### BRIEF DESCRIPTION OF DRAWINGS

FIG. 1 is a side view showing the schematic configuration of a gas turbine engine, a part of which is cut away, the gas turbine engine including an axial compressor according to an embodiment of the present invention.

FIG. 2 is a cross-sectional view of an upper half part of rotor discs and rotor blades, which is parallel to an axial direction.

FIG. 3 is a view of the rotor discs and the rotor blades, when viewed from a radially outward side.

FIG. 4 is a partial cross-sectional view of the rotor discs and the rotor blades, which is perpendicular to the axial direction.

FIG. 5 is a cross-sectional view of an upper half part of the rotor discs and the rotor blades, which is parallel to the axial direction, showing a modified example in which an opening formed between a platform and an opening edge of a blade groove is located upstream in the axial direction relative to the platform.

FIG. 6 is a view of the rotor disc and the rotor blades, when viewed from a radially outward side, showing a modified example in which the opening is intermittent slits each of which is formed between the platform and the opening edge of the blade groove.

FIG. 7 is a view of the rotor disc and the rotor blades, when viewed from a radially outward side, showing a modified example in which the opening is formed between platforms arranged in a circumferential direction.

### DESCRIPTION OF EMBODIMENTS

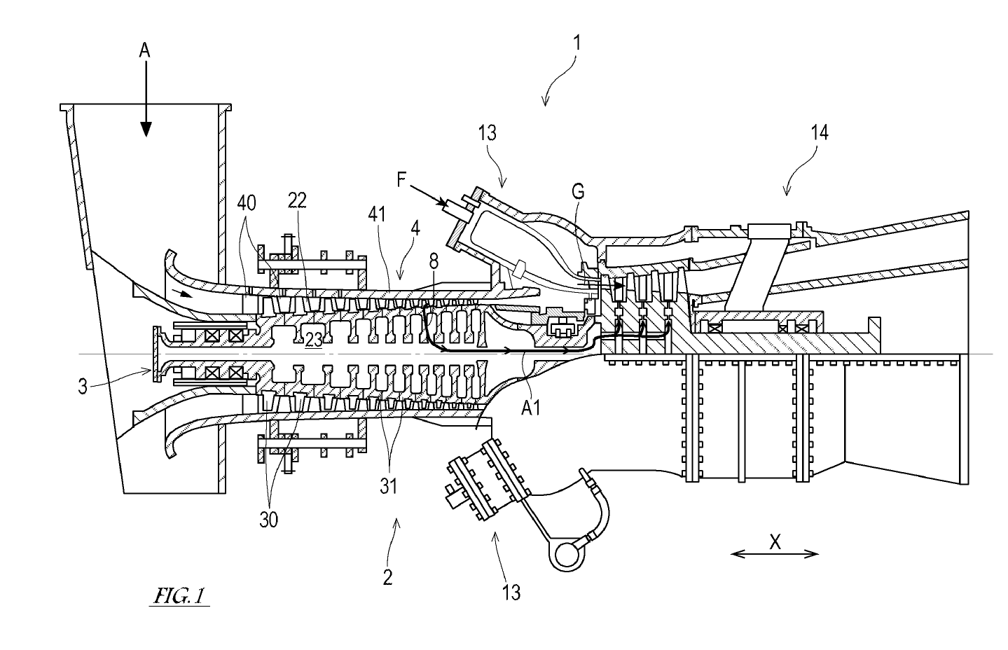

Hereinafter, the embodiment of the present invention will be described with reference to the drawings. First of all, the schematic configuration of a gas turbine engine 1 including an axial compressor (hereinafter will be simply referred to as a “compressor 2”) according to the embodiment of the present invention will be described with reference to FIG. 1. FIG. 1 is a schematic side view showing the inner structure of the gas turbine engine 1, a part of which is cut away.

The gas turbine engine 1 includes as basic components a compressor 2, a combustor 13, and a turbine 14. In the gas turbine engine 1, the compressor 2 is configured to take in and compress air A, and the combustor 13 is configured to combust fuel F with compressed air sent from the compressor 2 to the combustor 13 to generate a high-temperature and high-pressure combustion gas G. By energy of the high-temperature and high-pressure combustion gas G, the turbine 14 is driven. A rotor of the compressor 2 and a rotor of the turbine 14 are coupled to each other. By rotational driving power of the turbine 14, the compressor 2 and a load such as a generator (not shown) are driven.

Next, the compressor 2 will be described in detail. The compressor 2 has a double cylindrical structure extending in an axial direction (hereinafter will be simply referred to as “axial direction X”) of the compressor 2 and including a stator 4 located on an outer side and a rotor 3 (compressor rotor) located on an inner side.

The stator 4 includes a casing 41 and a plurality of rows of stator vanes (a plurality of stator vane rows) which are arranged in the axial direction X at the inner peripheral surface of the casing 41. Each of the plurality of rows of stator vanes includes a plurality of stator vanes 40 arranged at equal intervals in a circumferential direction.

The rotor 3 includes a plurality of rotor discs 31 arranged in the axial direction X, and a plurality of rotor blades (rotating blades) 30 arranged at equal intervals in the circumferential direction at the outer periphery of each of the rotor discs 31. The plurality of rotor blades 30 arranged in the circumferential direction constitute one row of rotor blades (one rotor blade row). The plurality of rows of rotor blades are arranged in the axial direction X. The plurality of rows of stator vanes and the plurality of rows of rotor blades are arranged in such a way that one row of stator vanes and one row of rotor blades are alternately placed in the axial direction X.

In the compressor 2 with the above-described configuration, a compressed air flowpath 22 is formed in a region between the stator 4 (casing 41) and the rotor 3 (rotor disc 31) in a radial direction, to compress the intake air A. The air A is taken in from a first (one) end portion of the stator 4 in the axial direction X, is led to the compressed air flowpath 22, and flows to a second (the other) side in the axial direction X while the air A is compressed. Here, based on a flow of the air A in the compressed air flowpath 22, an “upstream region (side)” in the axial direction X and a “downstream region (side)” in the axial direction X are defined.

Inside the rotor 3, an inner passage 23 defined by the plurality of rotor discs 31 is formed. The inner passage 23 extends in the axial direction X and is in communication with the interior of the turbine 14. The compressor 2 is provided with a bleed path 8 which bleeds to the inner passage 23 a part (some) of the fluid, namely, the compressed air in the compressed air flowpath 22, at a location that is an intermediate stage of the compressor 2. The compressed air (arrow A1 of FIG. 1) having been led to the inner passage 23 through the bleed path 8 flows through the inner passage 23 in the axial direction X, is sent to the turbine 14, and cools components provided inside the turbine 14. Although the bleed path 8 according to the present embodiment is configured to bleed the compressed air at a location that is an intermediate stage of the compressor 2, the bleed path 8 may be configured to bleed the compressed air at a location that is a first stage or a last stage of the compressor 2. Further, the bleed path 8 may be configured to bleed the compressed air at locations that are a plurality of intermediate stages of the compressor 2.

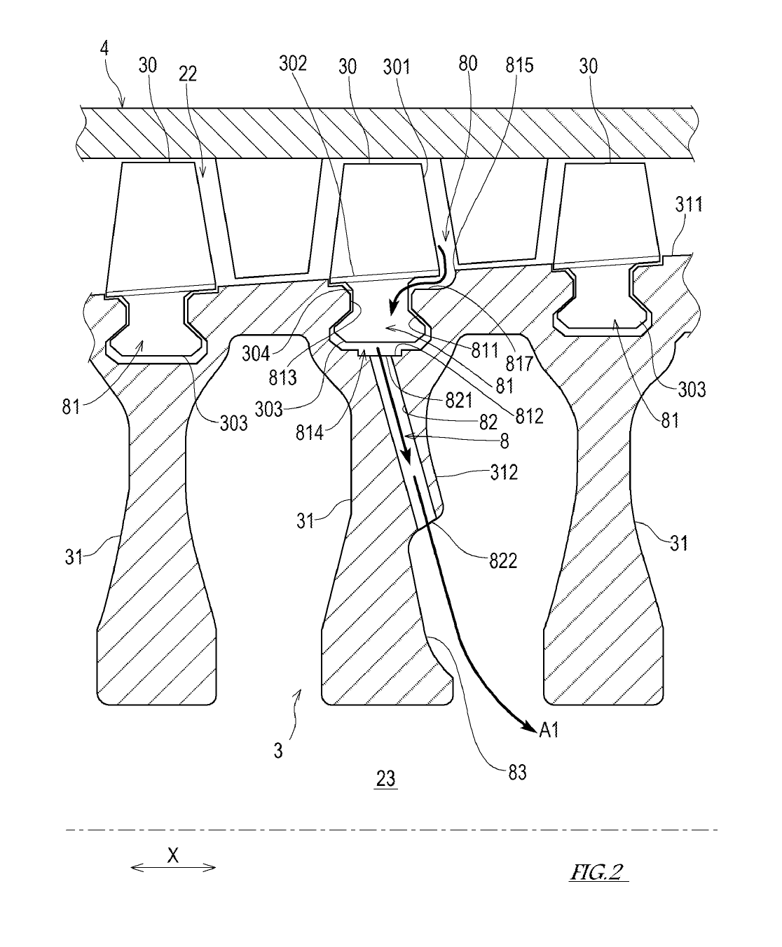

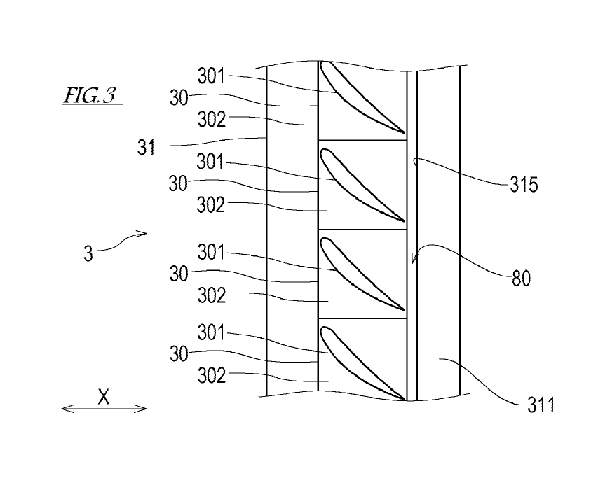

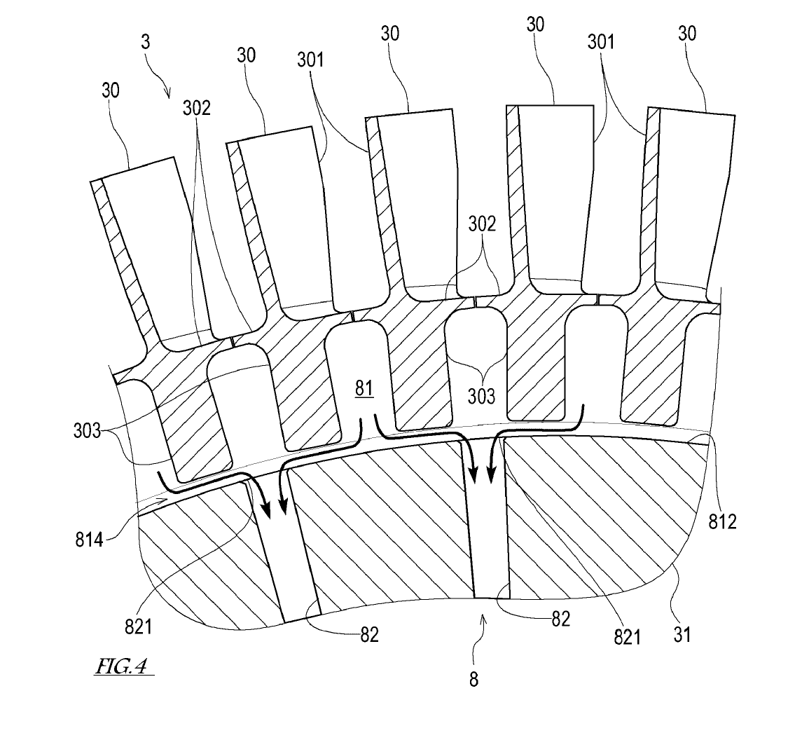

Next, the bleed path 8 will be described in detail. FIG. 2 is a cross-sectional view of an upper half part of the rotor discs 31 and the rotor blades 30, which is parallel to the axial direction X. FIG. 3 is a view of the rotor discs 31 and the rotor blades 30, when viewed from a radially outward side. FIG. 4 is a partial cross-sectional view of the rotor discs 31 and the rotor blades 30, which is perpendicular to the axial direction X.

As shown in FIGS. 2 to 4, each of the rotor blades 30 includes a blade part 301 on which the air flows during the operation (running) of the compressor 2, a root part 303 embedded in the rotor disc 31, and a plate-shaped platform 302 located between the blade part 301 and the root part 303 and joined to the blade part 301 and the root part 303, the blade part 301, the root part 303, and the platform 302 being integrated with each other.

In the present embodiment, the root part 303 of the rotor blade 30 is formed as a circumferential insertion dovetail. The root part 303 has a neck 304 which is a constricted part at a location that is in the vicinity of the platform 302. The dimension in the circumferential direction and dimension in the axial direction X, of the root part 303 are less than those of the platform 302.

Each of the rotor discs 31 has a disc shape with a thickness in the axial direction X. A blade groove (channel) 81 which opens in a radially outward direction is formed on the outer periphery of this disc. The blade groove 81 extends continuously in the circumferential direction, on the outer periphery of the rotor disc 31.

The cross-sectional shape of the blade groove 81 substantially conforms to those of the platform 302 and the root part 303 of the rotor blade 30 so that the platform 302 and the root part 303 of the rotor blade 30 are insertable into the blade groove 81 in the circumferential direction. Specifically, the blade groove 81 has a pair of side walls 811 facing each other, and a bottom wall 812. Protruding (swelling) parts 813 are provided in the side walls 811 at locations corresponding to the neck 304 of the root part 303 of the rotor blade 30. The neck 304 of the root part 303 of the rotor blade 30 is sandwiched between the protruding parts 813. In this way, the rotor blade 30 is retained and is not disengaged from the blade groove 81 in the radially outward direction. One of the side walls 811 has an outward surface 817 at a location that is in the vicinity of an opening edge 815, the outward surface 817 facing in the radially outward direction and facing the lower surface of the platform 302 with a predetermined gap formed in the radial direction. The outward surface 817 is continuous in the circumferential direction. The outward surface 817 and the opening edge 815 are smoothly connected to each other in the radial direction, by a curved surface.

The bottom wall 812 of the blade groove 81 and the root part 303 of the rotor blade 30 are spaced apart from each other in the radial direction. A space 814 which is continuous in the circumferential direction is formed between the bottom wall 812 and the root part 303 in the radial direction.

The platform 302 of the rotor blade 30 is fitted to the opening edge 815 of the blade groove 81 so that the platform 302 and an outer peripheral surface 311 of the rotor disc 31 are substantially coplanar with each other. To form a gap in the axial direction X between the opening edge 815 of the blade groove 81 and the platform 302 of the rotor blade 30, dimension in the axial direction X of the opening edge 815 of the blade groove 81 is set slightly larger than that of the platform 302. The gap in the axial direction X which is formed between the platform 302 and the opening edge 815 of the blade groove 81 in the above-described manner is an opening 80 which is a bleed air inlet of the bleed path 8. Through the opening 80, the compressed air in the compressed air flowpath 22 is led from a radially outward side of the platform 302 to the inner region of the blade groove 81. In the present embodiment, the opening 80 is provided only at a location that is downstream in the axial direction X, relative to the blade part 301 and the root part 303 of the rotor blade 30. In other words, a side of the platform 302 which is on an upstream side in the axial direction X is in contact with the opening edge 815 of the blade groove 81, while a side of the platform 302 which is on a downstream side in the axial direction X does not contact the opening edge 815 of the blade groove 81.

The blade groove 81 having the above-described shape has a slot (not shown) in at least one location to insert the platform 302 and the root part 303 of the rotor blade 30 from a radially outward side to a radially inward side. Through this slot, the platform 302 and the root part 303 of the rotor blade 30 are inserted into the blade groove 81. The rotor blade 30 inserted into the blade groove 81 is moved in the circumferential direction along the blade groove 81. By repeating the insertion of the rotor blade 30 into the blade groove 81 and the movement of the rotor blade 30 in the circumferential direction, a predetermined number of rotor blades 30 are inserted into the blade groove 81. After the last rotor blade 30 is inserted into the blade groove 81, this last rotor blade 30 and the rotor disc 31 are fastened to each other by a fastening member (not shown). In this way, the rotation of each of the rotor blades 30 with respect to the rotor disc 31 is prevented.

In a state in which the predetermined number of rotor blades 30 are inserted into the blade groove 81, as described above, a boundary wall of the compressed air flowpath 22 and the blade groove 81 is defined by the predetermined number of platforms 302 which are arranged continuously in the circumferential direction. The opening 80 formed between the platforms 302 and the opening edge 815 of the blade groove 81 is continuous in the circumferential direction. The opening 80 continuous in the circumferential direction constitutes an annual slit.

To guide the air having flowed into the blade groove 81 through the opening 80 to an inner entrance 821 of a passage 82 provided in the bottom wall 812 of the blade groove 81, an air passage is formed within the blade groove 81. Specifically, the lower surface of the platform 302 which is on a downstream side in the axial direction X, and the outward surface 817 of the side wall 811 of the blade groove 81 are spaced apart from each other in the radial direction, and the air having flowed into the blade groove 81 through the opening 80 flows through this space. In this way, the air is guided to a region of the blade groove 81, the region being close to a center in the axial direction X (a region that is in the vicinity of the root part 303). In each of the rotor blades 30, the circumferential dimension of the platform 302 is larger than that of the root part 303. In this structure, the root parts 303 of the rotor blades 30 which are adjacent to each other in the circumferential direction are spaced apart from each other in the circumferential direction, and this space is a part of an airspace within the blade groove 81. The air flowing into the blade groove 81 through the opening 80 and guided to a region that is in the vicinity of the root part 303 as described above, moves in the circumferential direction within the blade groove 81 through this airspace, and reaches the inner entrance 821 of the passage 82 which will be described later.

Inside the rotor disc 31, at least one passage 82 is provided to connect the inner entrance 821 which opens in the blade groove 81 to an exit 822 which opens in an outer surface which is radially inward relative to the inner entrance 821. In the present embodiment, a plurality of passages 82 are provided inside the rotor disc 31 and extend radially. Since the passages 82 are provided inside the rotor disc 31, they rotate with the rotation of the rotor 3. In view of this, the passages 82 are formed as elongated passages with a reduced cross-sectional area so that the swirl velocity of the fluid flowing through the passages 82 is almost equal to the rotation velocity of the rotor 3. The swirl velocity of the fluid in the exit of the rotor blade 30 and the swirl velocity of the fluid in the entrance of the opening 80 are lower than the rotation velocity of the rotor 3. In the opening 80, the fluid flows to connect the flow in the exit of the rotor blade 30 to the flow in the blade groove 81. The fluid within the blade groove 81 has a swirl velocity that is almost equal to the rotation velocity of the rotor 3, by the function of the root parts 303 present intermittently. Since the swirl velocity of the fluid within the passage 82 and the swirl velocity of the fluid within the blade groove 81 are almost equal to the rotation velocity of the rotor 3 as described above, a pressure loss of the fluid flowing from the blade groove 81 into the passage 82 can be reduced.

The inner entrance 821 of the passage 82 opens in a substantially center portion in the axial direction X, of the bottom wall 812 of the blade groove 81. The exit 822 of the passage 82 opens in a surface 312 of the rotor disc 31, the surface 312 being on a downstream side in the axial direction X. The passage 82 having such a shape extends from the inner entrance 821 to the exit 822 while having a radially inward component and a downstream component in the axial direction X. In the present embodiment, the number of the passages 82 provided in the rotor disc 31 is less than the number of the rotor blades 30. One passage 82 is provided to correspond to two rotor blades 30. However, the number of the passages 82 is not limited to this so long as at least one passage 82 is provided in the rotor disc 31. In the circumferential direction, the inner entrance 821 of the passage 82 is provided at a location that is between the root parts 303 of the rotor blades 30 which are adjacent to each other in the circumferential direction. The root parts 303 of the rotor blades 30 which are adjacent to each other in the circumferential direction are spaced apart from each other in the circumferential direction. An airspace formed between the adjacent root parts 303 is larger than an airspace at a location where the root part 303 of the rotor blade 30 is present.

The inner region of the blade groove 81 and the passage 82 constitute the bleed path 8 which bleeds a part of the compressed air in the compressed air flowpath 22 to the inner passage 23. The bleed air inlet of the bleed path 8 is the opening 80 formed between the platform 302 and the opening edge 815 of the blade groove 81. In accordance with the bleed path 8, a part of the fluid (compressed air) in the compressed air flowpath 22 is led to the inner region of the blade groove 81 through the opening 80, and the compressed air flows through the inner region of the blade groove 81 and thereafter flows into the inner passage 23 through the exit 822 of the passage 82.

At a location that is in the vicinity of the exit 822 of the passage 82, the rotor disc 31 has a guide part 83 which guides the fluid having flowed out through the exit 822 to a downstream region in the axial direction X. In the present embodiment, the inner peripheral portion of the surface 312 of the rotor disc 31, the surface 312 being on a downstream side in the axial direction X, is inclined to the downstream side in the axial direction X with respect to the radial direction as the inner peripheral portion of the surface 312 extends in the radially inward direction, and its inclination is significantly increased in its inner peripheral edge. In this structure, the inner peripheral portion of the surface 312 of the rotor disc 31 functions as the guide part 83.

As described above, the compressor 2 of the present embodiment includes the rotor (compressor rotor) 3 including the plurality of rotor blades 30 and the plurality of rotor discs 31. The rotor disc 31 includes the blade groove 81 which is provided in the outer peripheral surface 311 and is continuous in the circumferential direction, and the passage 82 which communicates the inner region of the blade groove 81 with the inner passage 23. Each of the rotor blades 30 includes the root part 303 and the platform 302 which are fitted to the blade groove 81, and the blade part 301 provided on a side opposite to the root part 303 with the platform 302 interposed between the root part 303 and the blade part 301. Between the opening edge 815 of the blade groove 81 and the platform 302, the opening 80 which communicates the inner region of the blade groove 81 with the compressed air flowpath 22 is provided.

In the compressor 2 and the rotor 3 thereof described above, the compressed air in the compressed air flowpath 22 located on the outer peripheral side flows into the blade groove 81 through the opening 80, and then is bled to the inner passage 23 located on the inner peripheral side, through the blade groove 81 and at least one passage 82 which are formed in the rotor disc 31. In brief, in the compressor 2 and the rotor 3 thereof, the inner region of the blade groove 81 and at least one passage 82 constitutes the bleed path 8 which bleeds a part of the fluid in the compressed air flowpath 22 to the inner passage 23 of the rotor 3. The bleed air inlet of the bleed path 8 is the opening 80 formed between the platform 302 and the opening edge 815 of the blade groove 81. At least one passage 82 is a passage which rotates with the rotation of the rotor 3. The inner region of the blade groove 81 is utilized as a circumferential passage (annular passage) connecting the passage 82 and the opening 80 (bleed air inlet) to each other.

As described above, in the compressor 2 according to the present embodiment, the blade groove 81 provided in the conventional rotor 3 is utilized as a part (annular passage which is continuous in the circumferential direction) of the bleed path 8. In this structure, for example, it is not necessary to form the annular passage (first passage) formed by the cooperation of the adjacent rotor discs disclosed in Patent Literature 1. This makes it possible to reduce a machined part of the rotor disc 31. As a result, machining cost can be reduced.

In the present embodiment, the opening 80 is provided at a location that is downstream in the axial direction X, relative to the blade part 301.

In this structure, the air having a swirl velocity component that is close to or equal to a rotation velocity component of the rotor 3 is bled, through the opening 80 provided at a location that is downstream in the axial direction X, relative to the blade part 301. Therefore, bleeding of the air can be stably performed.

In the present embodiment, the gap in the axial direction X which is formed between the end portion of the platform 302 in the axial direction X and the opening edge 815 of the blade groove 81 is the opening 80.

In this structure, the opening 80 can be provided at a location that is close to and downstream relative to the rotor disc 31. This can eliminate a need to expand the gap in the axial direction X between this rotor disc 31 and the stator vane 40 which is adjacent to and upstream relative to this rotor disc 31. Therefore, the dimension of the rotor 3 in the axial direction X is not increased.

In general, a portion of the rotor disc 31 which contacts the rotor blade 30 is required to have a thick wall structure to bear (withstand) a centrifugal force. For this reason, in the rotor of the compressor disclosed in Patent Literature 1, in which the bleed path is formed by the cooperation of the adjacent rotor discs, a portion which is the entrance of the bleed path has a large thickness. In addition, in the rotor of the compressor disclosed in Patent Literature 1, to reduce a pressure loss of the air flow, the bleed air inlet is provided at a location that is upstream relative to the stator vane which is subsequent to the rotor blade, and the axial gap formed between this rotor blade and the stator vane subsequent to this rotor blade is increased. For these reasons, the rotor of the compressor disclosed in Patent Literature 1 is unavoidably elongated in the axial direction. In contrast, in the rotor 3 according to the above-described embodiment, the inlet (the opening 80) of the bleed path is provided at a location that is close to and downstream relative to the rotor blade 30, and the axial position of this rotor blade 30 can conform to that of the stator vane 40 (to be precise, the outer peripheral portion of the stator vane 40) which is close to and downstream relative to this rotor blade 30. Therefore, the rotor 3 according to the present embodiment can have a structure which is shorter in the axial direction X than, for example, the convention rotor disclosed in Patent Literature 1.

In the compressor 2 and the rotor 3 thereof according to the present embodiment, the exit 822 which opens in the inner passage 23 is located downstream in the axial direction X relative to the inner entrance 821 which opens in the blade groove 81.

In this structure, the passage 82 is inclined to the downstream side in the axial direction X, from the inner entrance 821 toward the exit 822, and a component of the flow of the fluid flowing through the bleed path 8, the component being directed to the downstream side in the axial direction X, is increased.

In the compressor 2 and the rotor 3 thereof according to the present embodiment, the opening 80 forms the continuous annular slit, in the outer periphery of the rotor disc 31.

Since the opening 80 which is the inlet of the bleed path 8 has the annular slit shape, a part of the fluid in the compressed air flowpath 22 can be bled to the bleed passage 8 through the opening 80, without impeding the flow of the fluid in the compressed air flowpath 22.

In the compressor 2 and the rotor 3 thereof according to the present embodiment, the inner entrance 821 of the passage 82 opens in the bottom wall 812 of the blade groove 81, and the space 814 which is continuous in the circumferential direction is formed between the bottom wall 812 of the blade groove 81 and the root part 303 of the rotor blade 30.

In this structure, in the space 814 which is continuous in the circumferential direction, the fluid can move in the circumferential direction. Since the fluid present in the vicinity of the passage 82 flows into the passage 82 through the space 814, the number of passages 82 can be made less than the number of the rotor blades 30.

In the compressor 2 and the rotor 3 thereof according to the present embodiment, the rotor disc 31 has the guide part 83 which guides the fluid having flowed out through the exit 822 of the passage 82 to the downstream region in the axial direction X.

In this structure, the fluid having flowed out through the exit 822 of the passage 82 is guided by the guide part 83, and thus, the component of the flow which is directed to the downstream side in the axial direction X is increased. This allows the bled fluid to quickly flow to the downstream region in the axial direction X toward the turbine 14.

Although the preferred embodiment of the present invention has been described, the configurations of the compressor 2 and the rotor 3 thereof described above can be modified as follows.

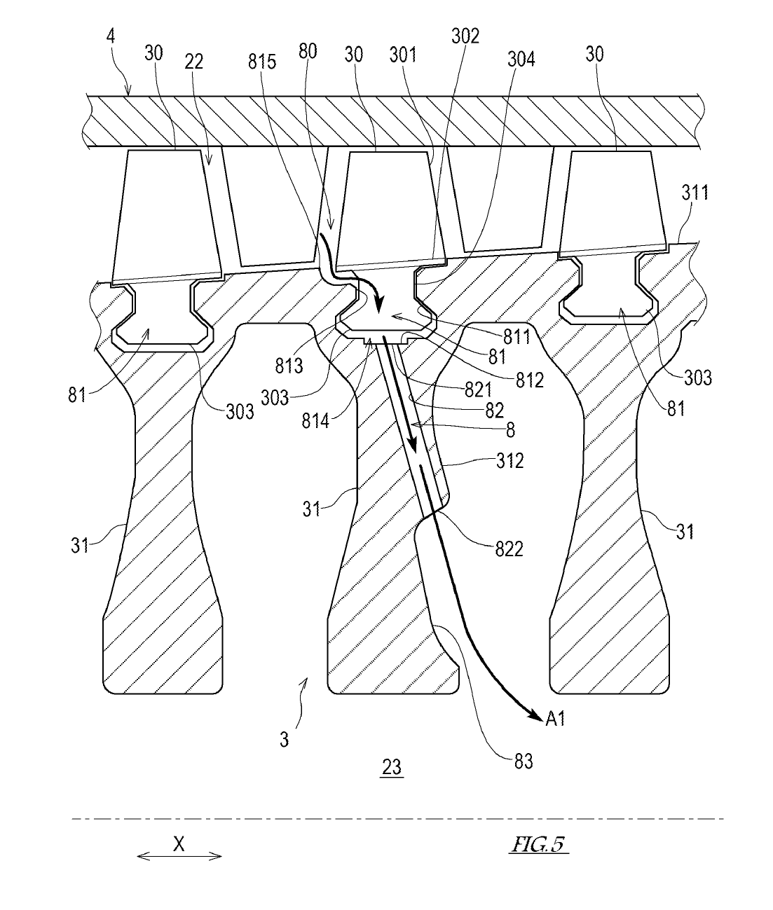

For example, in the above-described embodiment, the opening 80 which is the bleed air inlet of the bleed path 8 is located downstream in the axial direction X relative to the platform 302 so that the fluid having flowed along the blade part 303 (rotating blade) is led to the blade groove 81 through the opening 80. Alternatively, as shown in FIG. 5, by forming a gap in the axial direction X between the upstream side in the axial direction X of the platform 302 of the rotor blade 30 and the opening edge 815 of the blade groove 81 which is on an upstream side in the axial direction X, the opening 80 may be located upstream in the axial direction X relative to the platform 302. In a case where the opening 80 is located upstream in the axial direction X relative to the blade part 301 in this way, the fluid having flowed along the stator vane 40 is led to the blade groove 81 through the opening 80. Therefore, a fairing member (not shown) may be provided at a location that is upstream in the axial direction X relative to the opening 80 to accelerate the fluid with a swirl velocity component which is small or zero.

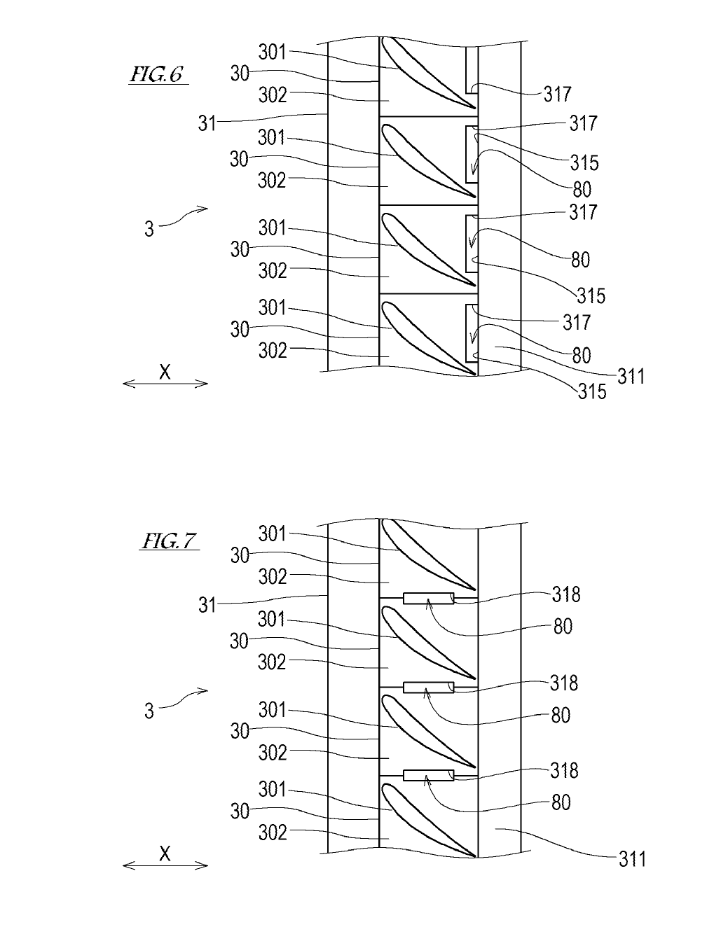

For example, in the above-described embodiment, the opening 80 is continuous in the circumferential direction, and forms the continuous annular slit in the outer periphery of the rotor disc 31. Alternatively, as shown in FIG. 6, the opening 80 may formed as openings provided intermittently in the circumferential direction in the outer periphery of the rotor disc 31. In the example of FIG. 6, the end portions of the platforms 302 of the rotor blades 30, the end portions being on a downstream side in the axial direction X, are provided with hollow spaces 317, and each of the openings 80 is formed by the hollow space 317 and the opening edge 815 of the blade groove 81 which is on a downstream side in the axial direction X.

The opening 80 is not particularly limited to the opening formed by the opening edge 815 and the platform 302 so long as the opening 80 is provided in the platform 302 or in a region that is in the vicinity of the platform 302 and is able to communicate the inner region of the blade groove 81 with the compressed air flowpath 22. For example, the opening 80 may be provided between the blade parts 301 which are adjacent to each other in the circumferential direction. In this case, for example, as shown in FIG. 7, a hollow space 318 may be provided in the end portion of one of or both of the platforms 302 of the rotor blades 30 which are adjacent to each other in the circumferential direction, and the opening 80 may be formed by the hollow space 318 between the platforms 302.

The description is to be construed as illustrative only, and is provided for the purpose of teaching those skilled in the art the best mode of conveying out the invention. The details of the structure and/or function may be varied substantially without departing from the spirit of the invention.

### REFERENCE SIGNS LIST

2 compressor

3 rotor

4 stator

8 bleed path

14 turbine

22 compressed air flowpath

23 inner passage

40 stator vane

41 casing

30 rotor blade (rotating blade)

31 rotor disc

80 opening (bleed air inlet)

81 blade groove

82 passage

83 guide part

301 blade part

302 platform

303 root part

812 bottom wall

814 space

815 opening edge

821 inner entrance

822 exit

1. A compressor rotor including a structure for bleeding air flowing through a compressed air flowpath of an axial compressor to an inner passage provided on an inner peripheral side of the axial compressor, the compressor rotor comprising:
a rotor disc including a blade groove provided in an outer peripheral surface thereof and being continuous in a circumferential direction, and a passage which communicates an inner region of the blade groove with the inner passage; and
a plurality of rotor blades each having a root part and a platform which are fitted to the blade groove, and a blade part provided on a side opposite to the root part with the platform interposed between the root part and the blade part,
wherein an opening is provided in the platform or a region that is in the vicinity of the platform and configured to communicate the inner region of the blade groove with the compressed air flowpath.

2. The compressor rotor according to claim 1,
wherein the opening is provided at a location that is downstream in an axial direction relative to the blade part.

3. The compressor rotor according to claim 1,
wherein the opening is a gap in an axial direction which is formed between an end portion of the platform in the axial direction and an opening edge of the blade groove.

4. The compressor rotor according to claim 1,
wherein the passage has a structure in which an exit which opens in the inner passage is located downstream in an axial direction relative to an entrance which opens in the blade groove.

5. The compressor rotor according to claim 1,
wherein the opening constitutes a continuous or intermittent annular slit in the outer peripheral surface of the rotor disc.

6. The compressor rotor according to claim 1,
wherein the passage opens in a bottom wall of the blade groove, and
wherein a space which is continuous in the circumferential direction is provided between the bottom wall of the blade groove and the root part.

7. The compressor rotor according to claim 1,
wherein the rotor disc includes a guide part which guides a fluid having flowed out to the inner passage through the passage to a downstream region in an axial direction.

8. An axial compressor comprising:
the compressor rotor recited in claim 1; and
a compressor stator including stator vanes corresponding to blade parts, respectively, of the compressor rotor.
